(19) United States
(12) Patent Application Publication
(10) Pub. No.: US 2024/0270638 A1
(43) Pub. Date: Aug. 15, 2024

(54) PRODUCTION OF CALCINED MATERIAL WITH SEPARATE CALCINATION OF EXHAUST DUST

(71) Applicant: REFRATECHNIK HOLDING GMBH, Munchen (DE)

(72) Inventors: Harry BOHNET, Calgary, Alberta (CA); Neil BONESKY, Calgary, Alberta (CA); Maryam JAFARI, Calgary, Alberta (CA); Gang SHI, Calgary, Alberta (CA); Franz Xaver SPACHTHOLZ, Calgary, Alberta (CA)

(73) Assignee: REFRATECHNIK HOLDING GMBH, Munchen (DE)

(21) Appl. No.: 18/568,948

(22) PCT Filed: Jun. 8, 2022
(86) PCT No.: PCT/CA2022/050913

§ 371 Date: Dec. 11, 2023

(30) Foreign Application Priority Data
Jun. 9, 2021 (DE) 10 2021 205 828.0

(51) Int. Cl. C04B 2/10; B01D 45/16; C04B 7/36

(52) U.S. Cl. CPC C04B 2/102; B01D 45/16; C04B 7/364

(57) ABSTRACT

A process for producing caustic calcined magnesia (CCM) includes calcining a magnesium containing material, such as magnesite, in a primary calciner to produce a primary calcined material and a primary exhaust comprising dust; subjecting the primary exhaust to separation to recover a dust material includes incompletely calcined dust particles; calcining the dust material in the secondary calciner to produce calcined dust, wherein the dust material is not co-calcined with the magnesium containing material or the primary calcined material. The primary calcined material and the calcined dues thus form two CCM products, which can be kept separate or combined. The primary calciner can be a multiple hearth furnace (MHF) while the secondary calciner can be a gas suspension calciner (GSC). Using a secondary calciner in such a manner can increase throughput of the primary calciner and provide other advantages for the calcination process.

### CROSS-REFERENCE TO RELATED APPLICATIONS

This application is the U.S. national phase of PCT Application No. PCT/CA2022/050913 filed on Jun. 8, 2022, which claims priority to German Patent Application No. 10 2021 205 828.0 filed on Jun. 9, 2021, which are incorporated herein by reference in their entireties.

### TECHNICAL FIELD

The technical field generally relates to methods and devices for the production of a mineral, granular calcined material from a granular mineral, preferably carbonate raw material.

### BACKGROUND

Granular materials can be calcined to produce calcined materials using various systems that include a calcination unit operated at relatively high temperatures. For example, caustic calcined magnesia (CCM) can be produced from raw magnesite or other raw granular magnesium containing materials. There are various challenges associated with calcination operations, such as efficiency and performance of the calcination as well as maximizing throughput.

### SUMMARY

Various aspects of enhanced calcination operations are described herein.

In some implementations, there is provided a process for producing caustic calcined magnesia (CCM), comprising: supplying a magnesium containing material to a primary calciner; calcining the magnesium containing material in the primary calciner to produce a primary calcined material and a primary exhaust comprising dust; removing the primary calcined material from the primary calciner as a first CCM material; removing the primary exhaust from the primary calciner; subjecting the primary exhaust to separation to produce a dust depleted gas and a dust material, wherein the dust material includes incompletely calcined dust particles; supplying the dust material to a secondary calciner; calcining the dust material in the secondary calciner to produce calcined dust, wherein the dust material is not co-calcined with the magnesium containing material or the primary calcined material; and removing the calcined dust from the secondary calciner as a second CCM material.

In some implementations, the primary calciner is a multiple hearth furnace (MHF). The secondary calciner can be a gas suspension calciner (GSC). In some implementations, there process includes subjecting the dust material to preheating prior to the calcining of the dust material. The preheating can be performed in preheating cyclones; the preheating cyclones can produce a preheated dust material that is fed into the secondary calciner, and a preheating cyclone exhaust. The preheating cyclone exhaust can be subjected to separation to produce a solids depleted gas and a recovered dust that is supplied into the secondary calciner.

In some implementations, there process can further include subjecting the calcined dust to cooling after removal from the secondary calciner. The cooling can be performed in cooling cyclones. The cooling cyclones can produce a cooled calcined dust and a cooling exhaust that is subjected to separation to produce a dust depleted cooled gas and a recovered cooled dust. The recovered cooled dust and the cooled calcined dust can be combined to form the second CCM material.

In some implementations, the separation of the primary exhaust is performed using an electrostatic separator, a filter, a baghouse, and/or one or more separation cyclones. In some implementations, the process includes cooling the primary exhaust prior to the separation.

The process can also include subjecting the primary calcined material to classification to produce multiple CCM fractions. The classification can be performed to produce a fine fraction, and can be performed to produce a coarse fraction, an intermediate fraction and a fine fraction. The fine fraction can be combined with the calcined dust to form a combined fine CCM material, but the calcined dust can alternatively be stored and handled separately from the primary calcined material.

In some implementations, all of the primary exhaust is subjected to the separation, and all of the dust material is supplied to the secondary calciner. In alternative scenarios, not all of the exhaust or dust is processed in this manner. In some implementations, for example, a recycle portion of the dust material is fed back into the primary calciner, and a second portion of the dust material is supplied to the secondary calciner.

In some implementations, the primary calciner comprises multiple calcination units operable in parallel. In some implementations, each of the multiple calcination units produces corresponding primary calcined material and primary exhaust, and the primary exhausts are subjected to separation together to produce a common dust material that is supplied to the secondary calciner.

In some implementations, the first CCM material and/or the second CCM material is subjected to sintering to produce a sintered magnesia. The first CCM material and/or the second CCM material can be subjected to a fusing process to produce fused magnesia.

In some implementations, only the dust material is supplied to the secondary calciner. It is also possible to co-feed the dust and an additional feed material to the secondary calciner. In some implementations, the dust material is co-supplied to the secondary calciner along with an additional magnesium containing feed.

In some implementations, the primary calciner is operated at a temperature of 600° C. to 1100° C., or 800° C. to 1100° C. In some implementations, the dust material is not compacted before calcination in the secondary calciner. In some implementations, the dust material supplied to the secondary calciner has a particle size distribution of d₉₀<150 μm. In some implementations, the dust material supplied to the secondary calciner has a particle size distribution of d₉₀<105 μm.

In some implementations, the secondary calciner is operated at a firing temperature of 600° C. to 1400° C., or 800° C. to 1100° C.

In some implementations, the magnesium containing material fed to the primary calciner is magnesite. In some implementations, the magnesium containing material fed to the primary calciner comprises a d₉₀ value<13 mm. In some implementations, the magnesium containing material fed to the primary calciner comprises a d₁₀ value<105 μm.

In some implementations, the magnesium containing material fed to the primary calciner is a mechanically processed, granular, mineral material. The primary calciner can be operated in countercurrent fashion.

In some implementations, there is provided the use of a calciner as a dust calciner for calcination of a magnesium containing feedstock material that consists of exhaust dust from an upstream calciner for the production of caustic calcined magnesia (CCM). The upstream calciner can be a multiple hearth furnace (MHF), and the dust calciner can be a gas suspension calciner (GSC). The CSC can have various configurations and can be operated based on various parameters.

In some implementations, there is provided caustic calcined magnesia (CCM) product consisting of calcined exhaust dust. The CCM product can have a loss on ignition (LOI) of 0 to 4% or 0 to 3%. The product can be unscreened, such that the CCM from the secondary calciner is not screened prior to packaging or sale, which is facilitated by the small size of the calcined dust. In addition, the CCM product can be milled after exiting the secondary calcination stage. Furthermore, the CCM product can be manufactured according to the process and/or systems as described herein and/or has one or more property as described herein.

In some implementations, there is provided a system for producing caustic calcined magnesia (CCM), comprising: a primary calciner comprising: a solids inlet configured to receive a magnesium containing material; a calcination chamber operable to calcine the magnesium containing material in the primary calciner to produce a primary calcined material and a primary exhaust comprising dust; a gas outlet for expelling the primary exhaust; and a solids outlet for expelling the primary calcined material as a first CCM material. The system also includes a gas-solid separator configured to receive the primary exhaust from the primary calciner and produce a dust depleted gas and a dust material, wherein the dust material includes incompletely calcined dust particles. The system further includes a secondary calciner comprising: a dust inlet configured to receive the dust material; a dust calcination chamber operable to calcine the dust material to produce a calcined dust and secondary exhaust; a gas outlet for expelling the secondary exhaust; and a solids outlet for expelling the calcined dust as a second CCM material. The system is configured to avoid co-calcination of the dust material with the magnesium contain material or the primary calcined material that are present in the primary calciner.

In some implementations of the system, the primary calciner is a multiple hearth furnace (MHF), and the secondary calciner is a gas suspension calciner (GSC). The system can also include a preheating stage configured to receive the dust material and produce a preheated dust and supplying the preheated dust to the secondary calciner. The preheating stage can include preheating cyclones. The system can also include a cooling stage configured to receive the calcined dust from the secondary calciner and produce a cooled calcined dust. The cooling stage can include cooling cyclones.

In some implementations, the gas-solid separator comprises an electrostatic separator, a filter or baghouse, and/or one or more separation cyclones.

In some implementations, the system includes a classification unit to produce multiple CCM fractions. The classification can include screens and configured to produce at least a coarse fraction, an intermediate fraction and a fine fraction. The system can also include a material transport assembly configured to transport all of the primary exhaust to the gas-solid separator, and all of the dust material to the secondary calciner. In some other implementations, a recycle assembly configured to recycle a portion of the dust material back into the primary calciner, and supply assemble configure to supply a second portion of the dust material to the secondary calciner. In some implementations, the primary calciner comprises multiple calcination units operable in parallel.

In some implementations, the primary calciner is operable at a temperature of 600° C. to 1100° C., and the secondary calciner is operable at a firing temperature of 600° C. to 1400° C. In some implementations, the primary calciner is operable in countercurrent fashion and the solids inlet and the gas outlet are at a same end of the primary calciner and are opposite the solids outlet.

In some implementations, there is provided a method for production of a granular, calcined material, comprising:

supplying raw material into a calciner furnace;

calcining the raw material into the oxide of the raw material in the calciner furnace, thereby producing:

calcined material; and

furnace exhaust gas comprising furnace exhaust dust;

removing the furnace exhaust gas from the calciner furnace;

subjecting the furnace exhaust gas to separation obtain a separated furnace exhaust dust comprising incompletely calcined dust particles; and

supplying the separated furnace exhaust dust to a secondary calciner that is separate from the calciner furnace; and

subjecting the separated furnace exhaust dust to secondary calcining in the secondary calciner not in the presence of at least a portion of the calcined material to generate a calcined furnace dust.

In some implementations, the calciner furnace is a Multiple Hearth Furnace (MHF), or a rotary kiln, or a shaft furnace, or a fluidized bed furnace. In some implementations, the raw material is calcined in the calciner furnace at a firing temperature of 600° C. to 1100° C., or 800° C. to 1100° C. In some implementations, none of the separated furnace exhaust dust is returned to the calciner furnace. In some implementations, the furnace exhaust dust is not compacted before calcination in the secondary calciner. In some implementations, the furnace exhaust dust supplied to the secondary calcining has a particle size distribution of d₉₀<150 μm. In some implementations, the furnace exhaust dust supplied to the the secondary calcining has a particle size distribution of d₉₀<105 μm. In some implementations, the furnace exhaust dust is subjected to the secondary calcining at a firing temperature of 600° C. to 1400° C., or 800° C. to 1100° C. In some implementations, the calcined material is classified into at least two fractions comprising at least a coarse fraction and fine fraction. In some implementations, the fine fraction comprises a maximum particle size<210 μm. In some implementations, the calcined material is classified into at least the coarse fraction, an intermediate middle fraction, and the fine fraction. In some implementations, each of the at least two fractions is stored separately. In some implementations, the calcined furnace dust is stored together with at least a portion of the calcined material. In some implementations, the calcined furnace dust is not classified. In some implementations, the calcined furnace dust is combined with the fine fraction. In some implementations, the calcined furnace dust is stored and used separately from the calcined material. In some implementations, the raw material supplied into the calciner furnace comprises a d₉₀ value<13 mm. In some implementations, the raw material supplied into the calciner furnace comprises a d₁₀-value<105 μm. In some implementations, the classifying is performed by screening. In some implementations, the granular, calcined material comprises caustic calcined magnesia. In some implementations, the granular, calcined material comprises quicklime. In some implementations, the granular, calcined material comprises caustic calcined dolomite. In some implementations, the raw material comprises mechanically processed, granular, mineral material. In some implementations, the raw material comprises a carbonate mineral. In some implementations, the raw material comprises raw magnesite and/or magnesium hydroxide and/or limestone and/or dolomite rock. In some implementations, the calciner furnace is vertical. In some implementations, the calciner furnace is operated in countercurrent fashion. In some implementations, the secondary calciner is a gas suspension calciner. In some implementations, the secondary calciner comprises an indirect fired rotary kiln. In some implementations, the secondary calciner comprises a fluidized bed calciner. In some implementations, the furnace exhaust dust is subjected to cyclonic preheating prior to being fed to the secondary calciner, and the calcined dust is subjected to cyclonic cooling after withdrawal from the secondary calciner.

In some implementations, there is provided a device for the production of a granular, mineral, calcined material, comprising: a calciner furnace for calcining of granular, mineral, raw material to the oxide of the raw material, thereby producing a calcined material and furnace exhaust gas; a furnace exhaust dust removal device for collecting a furnace exhaust dust contained in the furnace exhaust gas leaving the calciner furnace; and a separate calcining device for calcining the collected furnace exhaust dust separately from the calcined material, thereby producing a separate calcined furnace exhaust dust.

In some implementations, the calciner furnace is a Multiple Hearth Furnace (MHF) or a rotary kiln or a shaft furnace or a fluidized bed furnace. In some implementations, the separate calcining device is a gas suspension calciner. In some implementations, the separate calcining device is part of a secondary calcination system that comprises: an intermediate storage device for intermediate storage of the furnace exhaust dust to be calcined; a preheating stage for preheating the furnace exhaust dust to be calcined int the separate calcining device; a calcining stage comprising the gas suspension calciner for calcining the furnace exhaust dust; and a cooling stage for cooling the calcined furnace exhaust dust.

In some implementations, the secondary calcination system further comprises: a preheating stage exhaust dust removal device for collecting the furnace exhaust dust from exhaust gas leaving the preheating stage and means for feeding the collected furnace exhaust dust into the calcining stage; and a cooling stage exhaust dust removal device located downstream of the cooling stage for collecting a portion of the calcined furnace exhaust dust entrained in the exhaust gas leaving the cooling stage.

In some implementations, the preheating stage comprises multiple preheating cyclones. In some implementations, the calcining stage comprises a riser pipe for calcining the furnace exhaust dust, a calcining stage cyclone for collecting the calcined furnace exhaust dust and at least one burner for heating the furnace exhaust dust within in the riser pipe. In some implementations, the cooling stage comprises multiple cooling cyclones.

In some implementations, the device includes a classification device for classifying the calcined material into multiple streams based on particle size. In some implementations, the classification device comprises screens for classification. In some implementations, the device includes one or more heat exchanger located: downstream of the calciner furnace and upstream of the furnace exhaust gas dust removal device for cooling the furnace exhaust gas exhaust; and/or upstream of the preheating stage exhaust dust removal device for cooling the exhaust gas therefrom; and/or upstream of the cooling stage exhaust dust removal device for cooling the exhaust gas therefrom.

In some implementations, the secondary calciner is a gas suspension calciner, an indirect fired rotary kiln, or a fluidized bed calciner.

The device can be configured for the production of caustic calcined magnesia as the granular, mineral, calcined material; for the production of quicklime as the granular, mineral, calcined material; and/or for the production of caustic calcined dolomite as the granular, mineral, calcined material.

### BRIEF DESCRIPTION OF THE DRAWINGS

FIG. 1 is a schematic illustration of a process for the production of caustic calcined magnesia.

FIG. 2, including 2A and 2B, is a schematic illustration of an embodiment of a process for the production of the calcined material according to the technology described herein.

FIG. 3 is a schematic illustration of another embodiment of a process for the production of the calcined material according to the technology described herein.

FIG. 4 is a schematic illustration of a further embodiment of a process for the production of the calcined material according to the technology described herein.

### DETAILED DESCRIPTION

The present description relates to the production of calcined material where feed material is supplied to a primary calciner which produces a primary calcined material and primary exhaust that contains incompletely calcined dust, and the exhaust dust is recovered and supplied to a secondary calciner to produce calcined dust, such that the exhaust dust and the primary calcined material are not co-calcined together. The primary calciner can be a multiple hearth furnace (MHF) while the secondary calciner can be a gas suspension calciner (GSC). Various aspects, implementations and features of the technology will be described in further detail below.

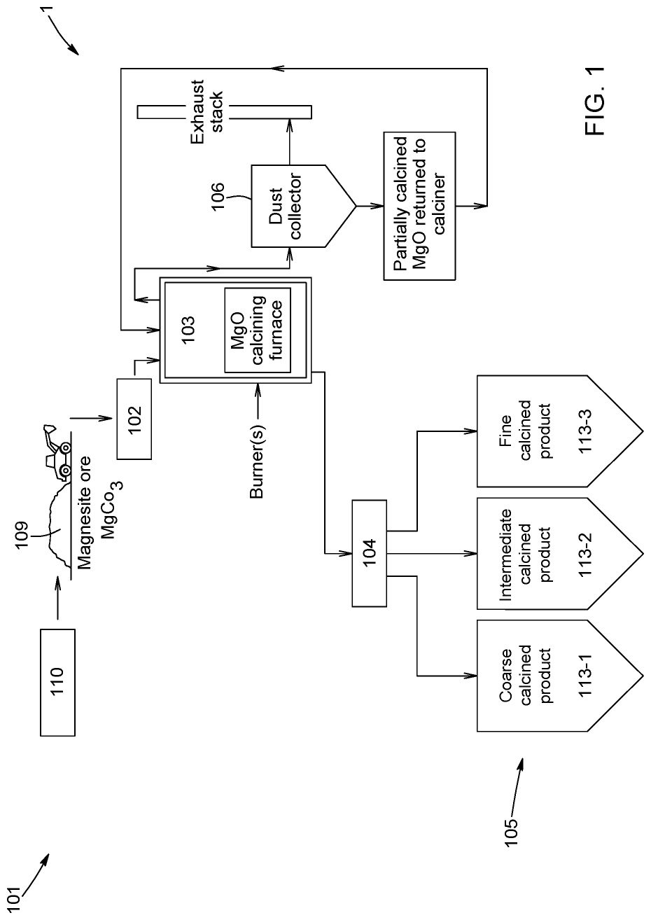

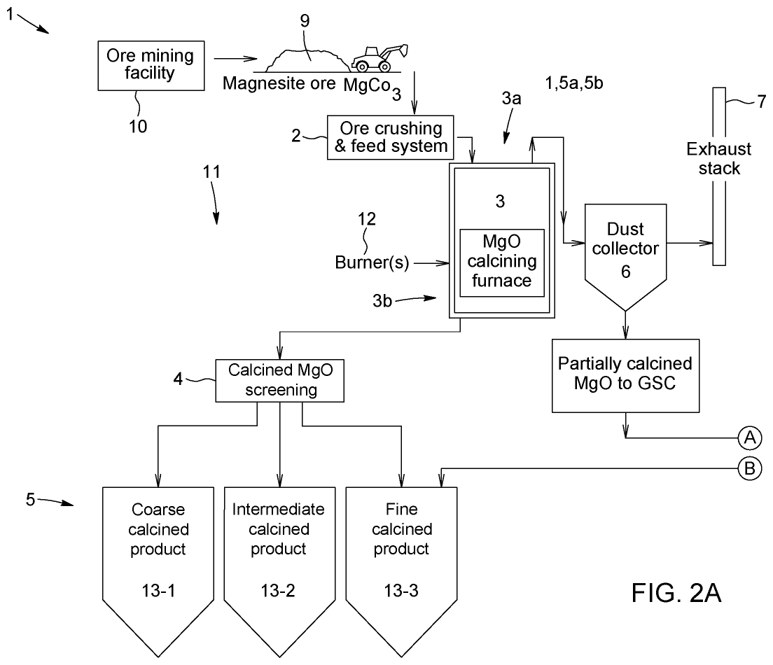

FIGS. 2 to 4 illustrate embodiments of the process where the exhaust dust of the primary calciner is supplied to a secondary calciner for separate calcination. These Figures can be contrasted with FIG. 1, which will be described in further detail below, where the exhaust of the calciner is removed and recycled back into the calciner, and the exhaust dust is thus co-calcined with the rest of the feed material.

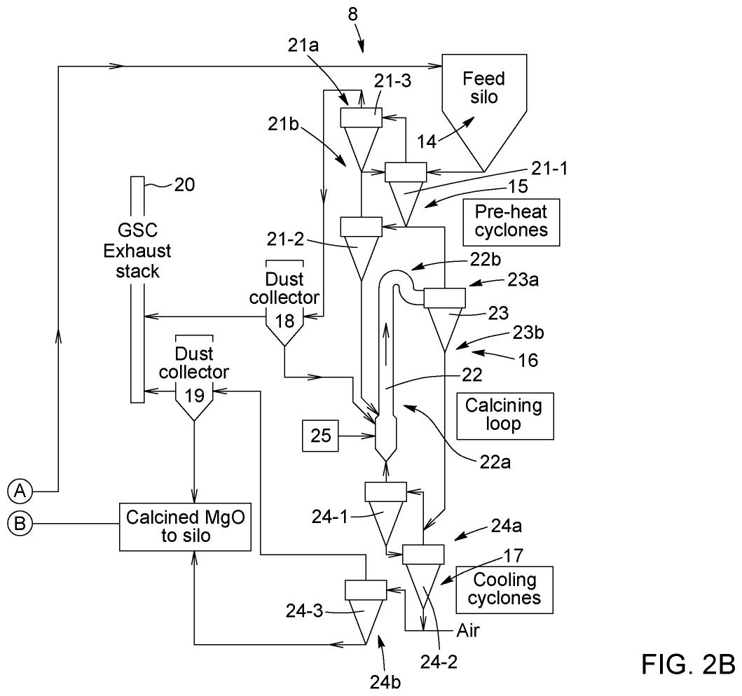

Referring now to FIG. 3, the calcination operation 200 can include a primary calciner 202 that receives a feed material 204 and generates primary calcined material 206 and primary exhaust 208. The primary calciner 202 can be various types of calciner reactors and can also include several units and equipment associated with calcination. The primary exhaust 208 contains dust particles that are incompletely calcined. The dust 210 can be separated from the exhaust stream in a dust separator 212 and the resulting dust 210 can then be fed to a secondary calciner 214. The dust depleted exhaust gas 216 can be fed to an exhaust stack or further treated if desired. At least a portion of the exhaust dust 210, preferably all of the dust produced by the dust separator 212, is supplied to the secondary calciner 214 which completes calcination of the dust and generates calcined dust 218 and secondary exhaust 220.

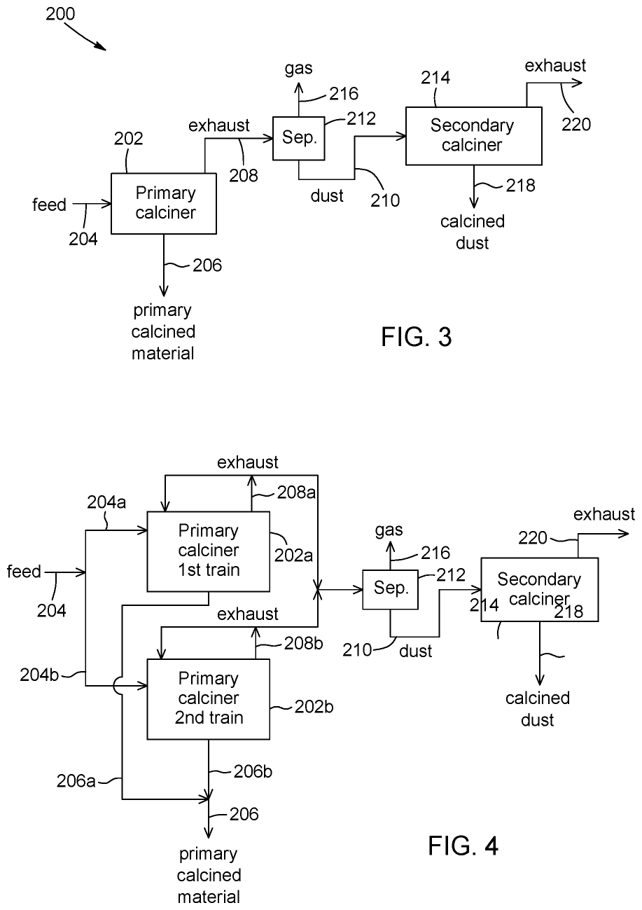

Removal and separate calcination of the dust from the primary exhaust facilitate complete calcination of the dust while increasing throughput opportunities in the primary calciner, since dust recycling can lead to a notable reduction in the ability of the calciner to receive raw feed material. The secondary calciner can be fully or partially dedicated to dust calcination and its addition to the calcination process can also facilitate process control options in certain circumstances, e.g., when associated with multiple primary calciners that are operated in parallel as shown in FIG. 4.

Referring in detail to FIG. 4, the calcination operation 200 can include multiple primary calciners 202a, 202b that receive the raw material which can be from the same or different sources. Feed streams 204a, 204b are supplied to the respective primary calciners 202a, 202b, which produce exhaust streams 208a, 208b as well as primary calcined material streams 206a, 206b. The exhaust streams 208a, 208b can be fully or partially combined together and supplied to the dust separator 212 to form a single dust stream that is fed to the secondary calciner 214. Alternatively, multiple dust separators could be provided for respective exhaust streams. It is also noted with reference to FIG. 4 that a portion of the primary exhaust can be recycled back into a primary calciner, while another portion is subjected to separation and the separated dust is fed to the secondary calciner 214. The proportion of dust that is recycled back to the primary calciner versus supplied to the secondary calciner 214 can be controlled based on various factors, such as target throughput and performance of the primary and secondary calciners. While the recycled portion of the exhaust dust can be supplied to the same primary calciner (e.g., 208a recycled back into 202a), it is also possible to feed the recycled portion of the exhaust dust into another primary calciner (e.g., 208a fed into 202b).

It is noted that the calcination operation can include various units and features, some of which are shown in more detail in FIG. 2. In addition, the system of FIG. 2 can also be compared to an alternative calcination system illustrated in FIG. 1, which does not include separate calcination of the dust and will be described in further detail below. In this regard, it is noted that the system of FIG. 1 could be adapted or retrofitted with methods described herein to incorporate the separate calcination of exhaust dust in a secondary calciner to enhance the system.

Referring now to FIG. 1, for conventional production caustic calcined magnesia (CCM) from raw magnesite in a generic device 101, raw magnesite obtained from a deposit 110 is first mechanically crushed in a crushing and feeding device 102 and the crushed, granular raw material 109 is then fed to the calciner furnace (which can also be referred to as a burning furnace) 103. The calciner furnace 103 could be a Multiple Hearth Furnace (MHF), a rotary kiln, a shaft furnace or a fluidized bed furnace. The granular raw material is calcined in the calciner furnace 103 typically at a firing temperature of 800° C. to 1100° C. During the calcination process, the magnesite is decomposed and magnesium oxide is produced by releasing CO₂ (MgCO₃→MgO+CO₂) and the resulting CCM is classified in a classification device 104 into fractions (e.g., coarse, medium, fine). The classified material is stored in silos 113-1; 113-2; 113-3 of a storage device 105. A fraction or “size class” can be viewed as having particle sizes defined by at least one boundary, e.g., a screen size, which may be between two boundaries. For example, fractions can be defined by the use of two screens that are 34 and 70 mesh with a first fraction being above 34 mesh, the second fraction being between 34 and 70 mesh and the third fraction being below 70 mesh.

By varying the firing temperature and firing time in the calciner furnace 103, CCM varieties with different reactivities can be produced. The particle size of the raw material fed into the calciner furnace 103 should be such that the raw material can pass through the calciner furnace 103 and leave it as a finished, calcined material. For this purpose, an upper limit can be set for the maximum particle size of the raw magnesite, which can be 13 mm for example. However, a lower limit is not usually set to avoid any loss of the raw material. As a result, the raw magnesite fed into the calciner furnace 103 can have a wide particle size distribution including very fine particles. In this regard, unless otherwise stated, the particle sizes indicated in the context of the present disclosure are determined in accordance with DIN 66165-2:2016-08.

Still referring to FIG. 1, calciner furnaces 103 can be operated in countercurrent fashion. The raw material to be calcined is conveyed from the furnace inlet to the furnace outlet, while hot process gas flows through the calciner furnace 103 in the opposite direction and thereby heats the raw material to be calcined. When the raw material reaches its calcination temperature, it begins to decompose. During decomposition, a notable proportion of very fine particles (which are also referred to as dust particles herein and can be the finest particles of the material) with a grain size below 105 μm is generated.

The dust particles that are present in the process lead to various issues. One issue is that the calcined material has a wide particle size distribution and is thus typically classified after calcination is complete. However, the very fine particles can reduce the effectiveness of the classification stage, e.g., due to plugging and clogging the screens of the classification device 104. Another issue is that the dust particles can be easily suspended in the air in part since a notable amount of process gas flows through the calciner furnace 103 at relatively high speed. The process gas flowing through the calciner furnace 103 is not only combustion gas, but also the evolved CO₂ from decomposition of the raw material. As a result, the exhaust gas leaving the calciner furnace 103, which is at the furnace inlet for countercurrent configurations, also contains a notable proportion of dust particles. In addition, these exhaust dust particles can be mostly non-calcined particles or not fully calcined particles, and it is desirable to capture and ensure calcination of the dust particles to form part of the calcined product. In the system shown in FIG. 1, the dust is re-supplied to the calciner furnace 103 itself. For this purpose, the exhaust gas is, if necessary, cooled in a heat exchanger 107, fed to a furnace exhaust dust removal device 106 to separate the furnace dust, and then the dust is fed back into the calciner furnace 103. However, an issue with this type of dust recycling is that a notable portion of the re-introduced dust can again be entrained in the process gas flowing through the calciner furnace 103 and is thus fed back to the furnace exhaust dust removal device 106. A notable amount of the dust thus circulates between the calciner furnace 103 and the furnace exhaust dust removal device 106, until such time as the dust particles are able to be discharged from the calciner furnace 103. In this configuration, the recycled dust particles can account for up to an additional 80 wt % of the total material fed to the calciner furnace 103 at the furnace inlet end.

While some dust recycling can optionally be maintained, the process can be modified as shown in FIGS. 2 to 4 such that at least a portion of the exhaust dust is not recycled but is rather supplied to a secondary calciner in which the dust is calcined separately from the rest of the material of in the primary calciner. The technology provides enhancements that can include enhanced efficiencies and performance for the production of a granular, calcined mineral material, preferably from a granular, mineral raw material. The technology can particularly be applied, for example, in the production of CCM from magnesite although the production of quicklime and/or calcined dolomite can also be envisioned. More details regarding potential raw materials as well as other optional features of the technology will discussed further below.

Referring now to FIG. 2, a more detailed embodiment of the process and device 1 will be described. The device 1 can include a crushing and feeding device 2, at least one calciner furnace 3 (which can also be referred to as a primary calciner), a classification device 4, a storage device 5, a furnace exhaust dust removal device 6 (which can also be referred to as a dust separator), a furnace exhaust gas shaft 7 and a gas suspension calciner 8 (which is an example embodiment of the secondary calciner).

The crushing and feeding device 2 facilitate the mechanical preparation, e.g., crushing and/or grinding of the raw material 9 to be calcined into a raw feed material with a target particle size distribution suitable for calcination in the calciner furnace 3. In addition, the crushing and feeding device 2 has equipment for feeding the granular raw feed material to the calciner furnace 3. The feed material preferably has a particle size of d₉₀<13 mm. The feed material also preferably has a continuous particle size distribution. In addition, the feed material may have a fine particle content with particles<105 μm. The feed material preferably comprises a particle size of d₁₀<105 μm.

If CCM is to be produced, the raw material is preferably raw magnesite (MgCO₃). The raw magnesite can preferably be mined and thus obtained a natural mineral deposit 10. However the raw material for the production of CCM can also be mixed materials that include magnesium carbonate as well as other magnesium containing compounds, such as magnesium hydroxide. If quicklime is to be produced, the raw material is preferably limestone. The limestone can be mined and thus obtained a natural mineral deposit 10. If calcined dolomite is to be produced, the raw material is preferably dolomite rock. The dolomite rock can be mined and thus obtained a natural mineral deposit 10.

Referring still to FIG. 2, the calciner furnace 3, which can be operated in the countercurrent principle, is used for calcining the raw feed material 9 that has been optionally pre-treated by crushing and/or grinding for example. The firing temperature of this calciner is usually 600° C. to 1100° C., preferably 800° C. to 1100° C., depending on the raw material. Preferably, the calciner furnace 3 is a multiple hearth furnace (MHF), but could also be a shaft furnace, a rotary kiln or a fluidized bed furnace.

In this regard, MHFs are vertical calciner furnaces. MHFs include several annular furnace areas arranged on top of each other with furnace surfaces to support the material to be calcined. The raw feed material to be calcined is fed from above and can be moved by rotating stirring arms on the furnace surfaces. The stirring arms are attached to a central shaft. The material continuously moves down through openings in the furnace surfaces or other openings. The process gas flows in the opposite countercurrent direction upward through the MHF.

The calciner furnace 3 has a furnace inlet end 3a, at which the raw material to be calcined enters, and a furnace output end 3b, at which the calcined material is discharged from the calciner furnace 3. The furnace output end 3b is thus positioned in opposed relation to the furnace inlet end 3a in a preferably vertical material transport direction 11. Fresh process gas, preferably in the form of fresh air, is also supplied into the MHF at the furnace output end 3b, while at the furnace inlet end 3a the furnace exhaust is discharged. The process gas thus flows through the calciner furnace 3 in a direction opposite to the material transport direction 11, i.e., countercurrently with respect to the solid material.

Furthermore, the calciner furnace 3 has at least one burner 12 for the production of a flame. The burner 12 can be arranged in the firing zone of the calciner furnace 3 where the raw material is calcined. During calcination, the raw material decomposes and a notable amount of very fine particles of calcined material, especially the magnesia particles, are formed. Overall, the calcined material, especially the CCM, has a very wide and preferably continuous particle size distribution. To handle broad size distributions, the device 1 can include a classification device 4 for classifying the calcined material. The classification device 4 is located downstream of the calciner furnace 3 in material transport direction 11. By means of the classification device 4, the calcined material can be classified into several, preferably three or more, fractions. Preferably, the calcined material is classified into a coarse fraction, a middle fraction and a fine fraction.

In some implementations, the classification device 4 can include at least one vibrating screen. When multiple fractions are to be produced, there can be several vibrating screens that define the particle sizes limits of each fraction. It is nevertheless noted that other types of screens can be used for classifying the calcined material.

Still referring to FIG. 2, downstream of the classification device 4, the storage device 5 can be provided for the storage of the classified material and/or fractions. For this purpose, the storage device 5 can include several silos 13. In particular, the storage device 5 has at least one silo 13 for each size fraction. If no classification is performed, there can be a single silo for storing all of the calcined material.

The dust-containing furnace exhaust is discharged from the calciner furnace 3 at the furnace inlet end 3a and fed to the furnace exhaust dust removal device 6 (which can also be referred to as a dust separator). The furnace exhaust dust removal device 6 is used for dust removal from the furnace exhaust, i.e., for the removal or separation of the furnace exhaust dust from the furnace exhaust gases. Various types of equipment can be used for dust removal from the exhaust. For example, the dust separator can include at least one electrostatic separator, at least one filter and/or at least one cyclone, or another gas-solid separation unit (e.g., a baghouse unit). Between the calciner furnace 3 and the furnace exhaust dust removal device 6, a heat exchanger can be provided for cooling the furnace exhaust.

The separated dust can then be supplied to the secondary calciner that can be part of a secondary system that includes various units such as those shown in FIG. 2. For example, the dust can be supplied by solids handling methods, e.g., conveyor, to a feed silo from which the dust is fed into pre-heating units followed by the secondary calciner to produce the calcined dust which is then cooled and eventually sent to storage. More regarding the dust and the processing of the dust in the secondary system will be described below.

The furnace exhaust dust preferably has a particle size of d₉₀<150 μm, especially d₉₀<105 μm. In addition, the solid dust particles of the furnace exhaust dust can be to a significant extent non-calcined or not fully calcined particles derived from the raw feed material. The amount of non-calcined or not fully calcined (e.g., partially calcined) solid dust particles in the furnace exhaust dust can vary depending on the operating conditions of the furnace and the granulometry and type of raw feed material but can range up to approximately 30 wt %. The separated exhaust dust is fed to the secondary calciner (e.g., a gas suspension calciner 8) where it is completely calcined, while the dust depleted furnace exhaust is fed to the furnace exhaust stack 7. It is noted that the degree of calcination of the dust can depend on various factors including the design and operation of the primary calciner as well as the nature of the feed material. The degree of calcination can be determined, for example, by measuring the loss on ignition (LOI) of the dust. In some implementations, the dust can have a degree of calcination of 20 to 80%, 30 to 70% or 40 to 60%. In some observations, the dust from an MHF has been found to have an LOI of approximately 30-35% which generally corresponds to approximately 48-59% calcined.

Referring to FIG. 2, the overall secondary calcination system includes the gas suspension calciner 8 as well as pre-treatment and post-treatment units. For example, the secondary calcination system preferably includes an intermediate storage device 14 (e.g., silo or hopper), a preheating stage 15, a calcining stage 16, a cooling stage 17, a preheating stage exhaust dust removal device 18, a cooling stage exhaust dust removal device 19, and a calciner exhaust gas stack 20. The secondary calcination system can also include one or more heat exchangers for cooling the exhaust and which are located upstream of the preheating stage exhaust gas dust removal device 18 and/or upstream of the cooling stage exhaust dust removal device 19. The preheating stage exhaust dust removal device 18 and/or the cooling stage exhaust dust removal device 19 can include an electrostatic separator, a fabric filter and/or one or more cyclones.

The intermediate storage device 14 is used for the intermediate storage of the furnace exhaust dust to be calcined and can be in communication with the dust separator 6. From the intermediate storage device 14, the furnace exhaust dust is fed to the preheating stage 15, which is used for preheating the furnace exhaust dust to be calcined. The preheating stage 15 preferably has several, preferably three or four, preheating cyclones 21-1, 21-2, 21-3. The preferred number of preheating cyclones 21-1, 21-2, 21-3 depends on various factors, such as mass flow rate, degree of calcination of the material to be calcined, desired degree of calcination of the calcined furnace exhaust dust, equipment sizing, and the process temperature. It is noted that the secondary calcination system can have additional equipment not shown in FIG. 2, such as additional preheating and cooling cyclones, some of which can also be referred to as dedusting cyclones and combustion cyclones. Various configurations and equipment can be used in the secondary calcination system, such as equipment for implementing GSC.

The preheating cyclones 21-1, 21-2, 21-3 are preferably tangential cyclone separators and each has a cyclone material inlet 21a, a cyclone solid material output 21b, and a gas outlet exiting the top of the cyclone. In some implementations, a first preheating cyclone 21-1 is connected to the intermediate storage device 14. The furnace dust to be calcined is fed from the intermediate storage device 14 to the material inlet 21a of the first preheating cyclone 21-1 and the pre-heated solids exit the material solid output 21b and enter a second preheating cyclone 21-2. From the solid material output 21b of the second preheating cyclone 21-2, the preheated furnace dust is fed to the calcining stage 16, particularly the riser pipe material inlet 22. The dust depleted gas from the gas outlet of the first preheating cyclone 21-1 is fed to the third preheating cyclone 21-3 for additional dust removal. The pre-heated dust from the solid material output 21b of the third preheating cyclone 21-1 is fed back into the first preheating cyclone 21-1 along with the dust depleted gas from the second preheating cyclone 21-2, while the dust depleted gas from the third preheating cyclone 21-3 is supplied to the preheating stage exhaust gas dust removal device 18, with the recovered preheated dust being fed into the calcination stage 16. This separated dust can be fed into the calcination stage as a distinct inlet, as illustrated, or co-fed with the preheated dust supplied from the second preheating cyclone 21-2. Exhaust gas from downstream cyclones can be fed into upstream cyclones to preheat the dust that mainly progresses in countercurrent fashion with respect to the exhaust gases. For example, the exhaust gas from the second preheating cyclone 21-2 helps to heat the furnace dust in the first preheating cyclone 21-1, and the exhaust gas from the calcining stage cyclone 23 helps to heat the furnace dust in the second preheating cyclone 21-2.

Still referring to FIG. 2, the calcining stage 16 is used for calcining the furnace exhaust dust, which has preferably been preheated. The calcining stage 16 preferably includes a secondary calciner, which may be a GSC type unit. The secondary calciner can include a riser pipe 22, a calcining stage cyclone 23 and at least one burner 25. The riser pipe 22 is used for calcining the preheated furnace dust and has a riser pipe material inlet 22a and a riser pipe material output 22b. The at least one burner 25 is arranged preferably adjacent to the riser pipe material inlet 22a. In the riser pipe 22, the furnace dust is calcined, at a firing temperature of 600° C. to 1400° C., preferably 800° C. to 1100° C.

The calciner stage cyclone 23 is arranged in fluid communication with the riser pipe material output 22b. The exhaust dust calcined in the riser pipe 22 is fed from the riser pipe material output 22b to the calciner stage cyclone 23 where it enters via a cyclone material inlet 23a. The calciner stage cyclone 23 also has cyclone solid material output 23b and a gas outlet. From the cyclone material output 23b, the separated calcined exhaust dust is expelled and fed to the cooling stage 17. In addition, the exhaust gas withdrawn from the calciner stage cyclone 23 is fed to the second preheating cyclone 21-2. This exhaust gas is thus used to heat the exhaust dust in the second preheating cyclone 21-2 and residual dust particles can be recovered.

The cooling stage 17 is used to cool the calcined furnace exhaust dust. The cooling stage 17 preferably has several, preferably two to three, cooling cyclones 24-1, 24-2, 24-3. The preferred number of cooling cyclones 24-1, 24-2, 24-3 can depend on various factors, such as mass flow rate, operating conditions of the secondary calciner, and the desired degree of cooling of the calcined furnace exhaust dust. The cooling cyclones 24-1, 24-2, 24-3 are preferably tangential cyclone separators. The cooling cyclones 24-1, 24-2, 24-3 each have a cyclone material inlet 24a, a cyclone material output 24b and a gas outlet.

In some implementations, a first cooling cyclone 24-1 is connected to the calciner stage cyclone 23 to receive the hot calcined dust. The calcined furnace dust is fed from the calciner stage cyclone 23 to the cyclone material inlet 24a of the first cooling cyclone 24-1. The furnace dust separated in the first cooling cyclone 24-1 is removed via its solid material outlet 24b and then fed to a second cooling cyclone 24-2. The heated exhaust gas exiting the first cooling cyclone 24-1 at its gas outlet is fed back into the riser pipe 22, optionally at a lower inlet of the riser pipe 22 that is distinct from the riser pipe material inlet 22a that receives the preheated dust, although other inlet configurations are possible. In the illustrated implementation, the riser pipe 22 of the gas suspension calciner 8 can be operated in co-current fashion in terms of solid and gas flow.

Still referring to FIG. 2, the further cooled, calcined furnace dust which was separated in the second cooling cyclone 24-2 and expelled via its solid material outlet 24b can then be fed together with fresh gas, e.g., fresh air, to a third cooling cyclone 24-3. The heated exhaust gas exiting the top of the second cooling cyclone 24-2 can be fed to the first cooling cyclone 24-1 together with the hot calcined furnace dust from the calciner stage cyclone 23.

From the solid material output 24b of the third cooling cyclone 24-3, the cooled, calcined furnace dust can then be fed to a storage unit, such as a separate dust silo or a combined silo that includes a fraction of the primary calcined material (e.g., silo 13-3 that receives the calcined fine fraction). Since the dust is already a relatively fine material, the classification device 4 can be bypassed and the calcined dust can be supplied directly to storage. It is noted that the dust can be combined with another fraction of calcined material, or can be stored, packaged and sold as a distinct product that is not recombined with other calcined materials. The exhaust gas emanating from the third cooling cyclone 24-3 can be fed to the cooling stage exhaust dust removal device 19 to separate entrained calcined dust from the exhaust gas. As noted in FIG. 2, the calcined dust from the cooling stage 17 can be combined with calcined dust that is recovered from one or more dust separators (e.g., cooling stage exhaust dust removal device 19) part of the secondary calcination system. The exhaust gas exiting the cooling stage exhaust dust removal device 19 is fed to the exhaust stack 20.

Thus, dust particles contained in the primary furnace exhaust and which are at most partially calcined (e.g., being partially calcined or not calcined at all) are supplied from the calciner furnace 3 and calcined in an integrated yet separate calcination operation. This means that part or all of the furnace exhaust dust withdrawn from the primary furnace exhaust is not calcined together with the raw material but in a separation calcination operation. This configuration can facilitate reducing the total energy consumption required for calcining and notably increases the throughput capacity of raw material in the primary calciner since dust recycling is reduced or eliminated. In addition, calcining of fine particles in the gas suspension calciner 8 is efficient, particularly compared to dust calcination that relies on recycling back into the primary calciner. Furthermore, the energy intensity of the calciner furnace 3 can be lowered by the removal or reduction of the furnace dust from the calciner furnace 3.

In addition, dust recycling typically involves several cycles of cooling and re-heating of the dust to protect downstream equipment from damage, notably since dust circulates within the primary calcination system as described above. However, for the configuration where the dust that is withdrawn and calcined in a secondary calcination system, the dust reheated only once in the preheating stage 15 which can save overall heating energy. Thus, energy consumption can be reduced while increasing throughput. Indeed, the amount of raw material that is fed to the calciner furnace 3 can be increased since all of the furnace dust is no longer returned to the calciner furnace 3, and this approach also increases the efficiency of the calciner furnace 3 itself, e.g., as the proportion of dust in the material present in the calciner furnace is reduced compared to a full recycle approach. A further advantage is that the screens of the classification device 4 experience reduced clogging issues since the calcined material exiting the calciner 3 has a significantly lower amount of dust sized particles. In addition, the calcined furnace dust exiting the gas suspension calciner 8 has a small size and distribution such that the dust does not require screening or classification, but can be fed directly into a storage silo, e.g., 13-3, as a fine product. The efficiency of the classification device 4 is also enhanced due to the reduction of incoming fine dust particles.

As noted above, the calcination device 1 can include several, especially parallel operated, calciner furnaces 3 and/or several, especially parallel operated, secondary calciners. The furnace exhaust dust that emanates from each calciner furnace 3 can be calcined in a corresponding secondary calciner or in a single secondary calciner. In some implementations, multiple primary calciners are operated in parallel with the exhaust dust of each being subjected to secondary calcination at the same time. It is also possible to operate the multiple primary calciners in alternating fashion, where one is put offline for maintenance or cleaning while the other is operated at full or high throughput and then operation of the two primary calciners is switched. The multiple primary calciners can be operated in various modes depending on input feed rate of the raw material, storage capacity, product demand, process operating conditions, among other factors.

While the secondary calciner is preferably a gas suspension calciner 8 for calcining the exhaust dust, other type of calciners can be used. For example, the secondary calciner can be a calcining device that includes an indirect fired rotary kiln or with a fluidized bed calciner. Preferably, the dust particles of the furnace exhaust dust are suspended during secondary calcination, e.g., suspended or dispersed in a gaseous medium, especially in the combustion gas.

It is also noted that the dust particles are preferably not subjected to any compaction before secondary calcination. In some implementations, the dust can be cooled, separated, stored and supplied to the preheating stage of the secondary calcination system, but the dust is otherwise subjected to no other treatments prior to calcination. The dust therefore remains as a generally loose granular solid material capable of solid flow, e.g., into and out of a silo, as well as entrainment in a gas flow, e.g., through the cyclones and the secondary calciner. The design and operation of the preheating stage, cooling stage, and secondary calcination equipment can be provided based on the fine granular quality of the dust.

While the preheating stage 15 and/or the cooling stage 17 preferably include cyclones as described herein, these stages could also include other preheating or cooling equipment in addition to or instead of the cyclones. The cooling stage 17 can, for example, include one or more fluidized bed coolers and/or one or more rotary drum coolers that may be cooled by water.

Furthermore, while the secondary calciner preferably receives only exhaust dust from the primary calciner, it is also possible to feed additional materials into the secondary calciner for co-calcination with the dust. For example, a portion of raw material can be co-fed into the secondary calciner along with the exhaust dust. Such co-fed raw material could be fine such that it has a similar granulometry compared to the exhaust dust, and it could thus be pre-ground or screened to provide a target particle size distribution. In this optional case, the proportion of dust compared to addition feed material can be adjusted, though the dust proportion can be dominant to be over 50%, over 70% or over 90%.

It is also noted that the calcined dust can be viewed as a finished product that is sold or used, or it can be further treated to produce a final product. For example, the calcined dust could be supplied to a sintering stage to produce a sintered material or a dead-burning stage. When the calcined dust is composed of CCM, the CCM can be converted to dead burned magnesia (DBM).

It is further noted that the CCM material stream produced by the process can be subjected to further size modification, e.g., by milling, to produce target surface and size properties of the CCM products for various applications. The calcined material from the primary calcination system can be subjected to milling prior to classification, and the calcined dust can also be milled to target specifications.

The following section provides additional information and details regarding potential equipment and applications of the technology described herein.

Gas suspension calciners (GSCs) can be used for drying, preheating, calcining or dehumidification of various raw materials, e.g., lime, lime sandstone, raw magnesite and dolomite. While different designs are possible, GSCs generally work based on the suspension of the solid particles using gas flow. With GSCs, materials with grain sizes from above 0 mm up to 2 mm—in exceptional cases even up to 4 mm—can be thermally treated. In some implementations, a GSC would include several cyclone stages arranged on top of each other and a calciner riser pipe for drying, preheating and pre-calcining of the material. GSCs are generally used to produce a finished product without the need for an additional unit, such as a rotary kiln. However, an additional furnace may be used in conjunction with or downstream of a GSCs, e.g., to adjust the reactivity of the manufactured product.

As mentioned above, implementations of the technology can be used to produce calcined, granular, mineral products, such as CCM, quicklime and/or caustic calcined dolomite. The feedstock materials used for the production of the calcined products can include mined ores that include carbonates of calcium and/or magnesium. The carbonate raw material can have a composition that is predominantly (e.g., above 50 wt % and optionally above 70 wt %) carbonates and, in this sense, a raw material that only contains carbonate impurities would not be viewed as a carbonate raw material. It is also possible to have hydroxides, such as Mg(OH)₂, present in the raw material and converted to oxides, such as MgO, through calcination. Of course, magnesite has been used as raw material for the production of CCM (see, e.g., Practice Manual Fire-Solid Materials, Gerald Routschka/Hartmut Wuthnow, 5th edition, chapter 4.2.1). The raw magnesite is the naturally occurring mineral of magnesium carbonate (MgCO₃), which often is found together with dolomite (CaMg(CO₃)₂) in ore deposits. Various ore deposits can be mined to obtain ore that can be pre-processed if desired to prepare the feedstock suitable for the calcination methods describe herein.

Caustic calcined magnesia (CCM) can be used directly in various applications or further processed, e.g., converted to sintered magnesia or fused magnesia. CCM, sintered magnesia and fused magnesia are materials that are used in the production of refractory products, for example. CCM can also be used in applications such as animal feed, water treatment (especially waste water treatment), flue gas desulphurization, and pulp and paper industry. CCM can be used in various specific applications in industrial, agricultural and environmental fields.

In terms of operating conditions, calcination for producing CCM from magnesite is typically performed at temperatures between 600° C. and 1100° C., preferably between 800° C. to 1100° C. The calcination temperature and residence time can have an impact on the product's reactivity and other properties.

Sintered magnesia is produced by sintering a feed material, such as calcined magnesia, at temperatures typically above 1700° C. The sintered magnesia can be produced in a single-stage process within shaft or rotary kilns, for example. One process includes producing CCM in an MHF, pressing the granular CCM into briquettes, and then subjecting the briquettes to sintering in a shaft or rotary kiln at 1500-1900° C. (two-stage fired) to produce the sintered product. Fused magnesia (FM) can be produced by melting in an electric arc furnace at temperatures typically above 2850° C.

Quicklime (calcined CaO) can be produced by calcining limestone (CaCO₃) in a lime kiln. Beginning at a temperature of approximately 800° C., calcium carbonate is decarbonized with the carbon dioxide being driven out and calcium oxide is generated. In a similar manner, calcined dolomite (calcined CaO·MgO) can be generated by calcining dolomite rock (CaMg(CO₃)₂).

1. A process for producing caustic calcined magnesia (CCM), comprising:
supplying a magnesium containing material to a primary calciner;
calcining the magnesium containing material in the primary calciner to produce a primary calcined material and a primary exhaust comprising dust;
removing the primary calcined material from the primary calciner as a first CCM material;
removing the primary exhaust from the primary calciner;
subjecting the primary exhaust to separation to produce a dust depleted gas and a dust material, wherein the dust material includes incompletely calcined dust particles;
supplying the dust material to a secondary calciner;
calcining the dust material in the secondary calciner to produce calcined dust, wherein the dust material is not co-calcined with the magnesium containing material or the primary calcined material; and
removing the calcined dust from the secondary calciner as a second CCM material.

2-113. (canceled)
